(19) United States
(12) Patent Application Publication
(10) Pub. No.: US 2005/0251523 A1
(43) Pub. Date: Nov. 10, 2005

(54) Minimizing downtime for application changes in database systems

(75) Inventors: Kumar Rajamani, Santa Clara, CA (US); Guhan Viswanathan, Union City, CA (US); Warren Li, Redwood City, CA (US); Chandrasekharan Iyer, Belmont, CA (US)

Correspondence Address: BINGHAM, MCCUTCHEN LLP, THREE EMBARCADERO CENTER, 18 FLOOR, SAN FRANCISCO, CA, 94111-4067, US

(73) Assignee: ORACLE INTERNATIONAL CORPORATION, REDWOOD SHORES, CA (US)

(21) Appl. No.: 10/841,377

(22) Filed: May 7, 2004

(51) Int. Cl. G06F 7/00

(52) U.S. Cl. 707/100

(57) ABSTRACT

A method and apparatus for updating applications in the database are disclosed. A schema of an original database system is generated and updated while the original database system is online. Upon updating the original database system, synonyms are repainted to an original data storage after successful testing of the schema.

### FIELD

Embodiments of the invention relate generally to the field of database management and, in particular, to updating database systems.

### BACKGROUND OF THE INVENTION

Updating database systems usually requires taking database systems offline for a significant amount of time, while the necessary changes are introduced and successfully tested. Database downtime affects performance of applications that may interact with database systems, it also affects human performance that depends on data stored in those database systems. For example, taking down database systems providing online banking web services for any amount of time will affect user's ability to access their bank accounts and affect customer service satisfaction; taking down database systems utilized by agents in call centers, will affect agents' ability to service incoming calls.

What is needed, therefore, is a solution that overcomes these and other shortcomings of the prior art.

### SUMMARY OF THE INVENTION

Method and apparatus for updating applications in the database are disclosed. Embodiments of the invention include generating a schema of an original database system and updating the schema while the original database system is online. Embodiments further include repointing at least one synonym to an original data storage upon updating the original database system after successful testing of the schema.

### BRIEF DESCRIPTION OF THE DRAWINGS

The invention is illustrated by way of example and not limitation in the figures of the accompanying drawings, in which like references indicate similar elements and in which:

FIG. 1 illustrates an exemplary system architecture according to one embodiment of the invention;

FIG. 2 is a flow chart of database system update process according to one embodiment of the invention;

FIG. 3 illustrates original database system and schema according to one embodiment of the invention;

FIG. 4 illustrates original database system and schema upon successful testing of database system updates according to one embodiment of the invention;

FIG. 5 illustrates updated database system according to one embodiment of the invention; and

FIG. 6 illustrates a conventional processing system.

### DETAILED DESCRIPTION

Methods and apparatuses for updating database systems are described. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those skilled in the art. Thus, the invention can include any variety of combinations and/or integrations of the embodiments described herein.

### Exemplary Architecture

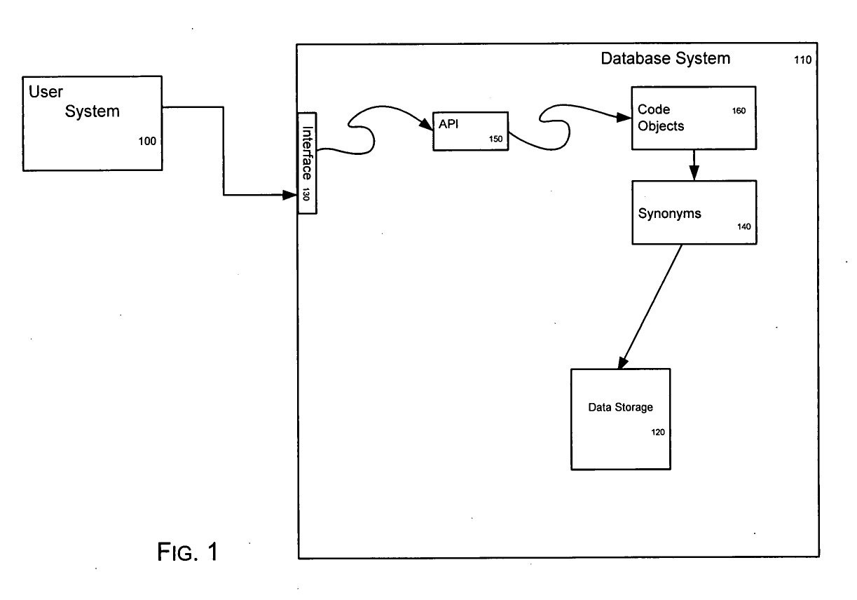

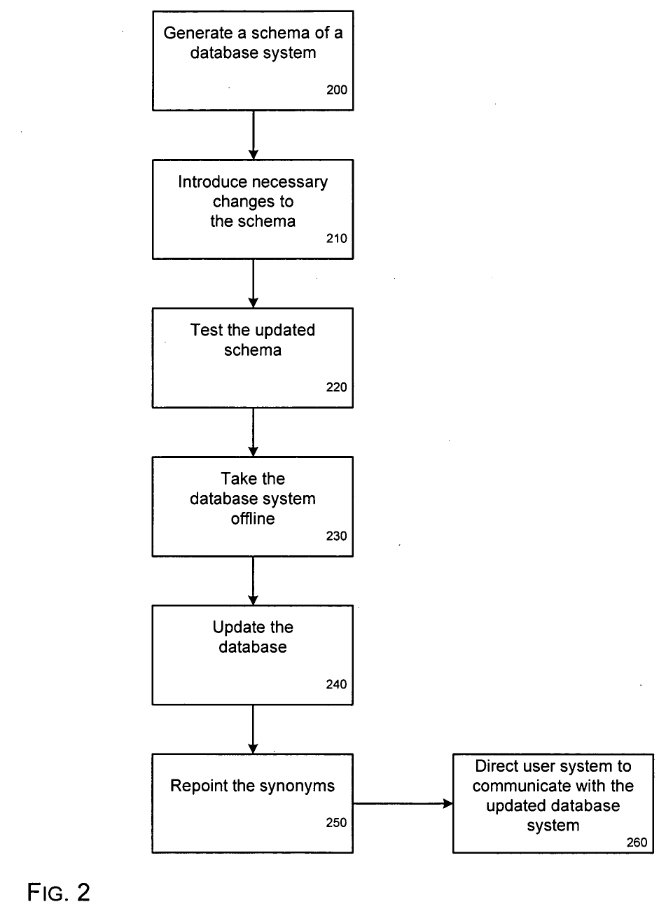

FIG. 1 illustrates an exemplary architecture according to one embodiment of the invention. A user system 100 communicates with a database system 110 via an interface 130. The interface 130 may be a command line interface or a graphical user interface. The operations specified by a user of the user system via an interface 130 are performed utilizing Application Programming Interface (API) 150 calls. For example, addition of a new employee data to a data storage 120 is performed via an API call of an add_employee function according to one embodiment, wherein the add_employee function adds the new employee data to an employee data table of the data storage 120. Code objects 160 access data storage 120 via synonyms 140 in response to an API call. A synonym is an alternative name of a database table, database view or another synonym. Synonyms represent a convenient way to address tables that are contained in another schema. For example, if a view called employee_details is contained in the schema called humanresources_department, the full name of the view is humanresources_department.employee_details. This view may be referenced from the schema called marketing_department by its fully qualified name as given above. Alternatively, a synonym may be created for the view in schema marketing_department, e.g. emp_details, to associate with the view humanresources_department.employee_details. Then the name emp_details can simply be used to refer to the view humanresources_department.employee_details. In other words, a synonym is a pointer to a database table, view or another synonym.

It will be appreciated that user system and database system may reside on the same processing system, or may communicate via network connections in a local or wide area networks.

### Methodology

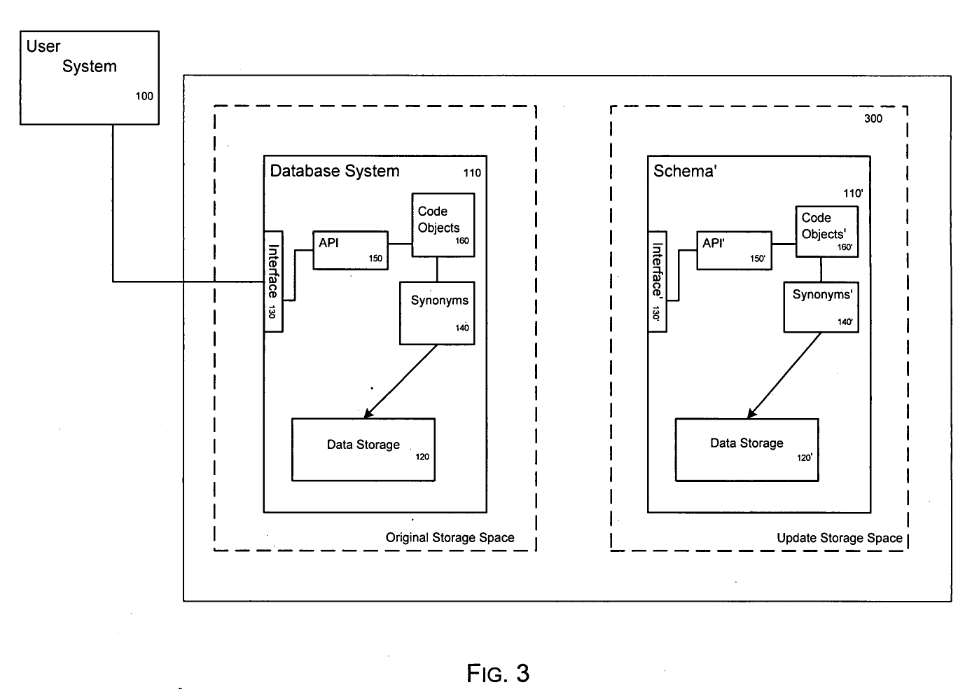

With these concepts in mind embodiments of the invention can be further described with reference to FIG. 2.

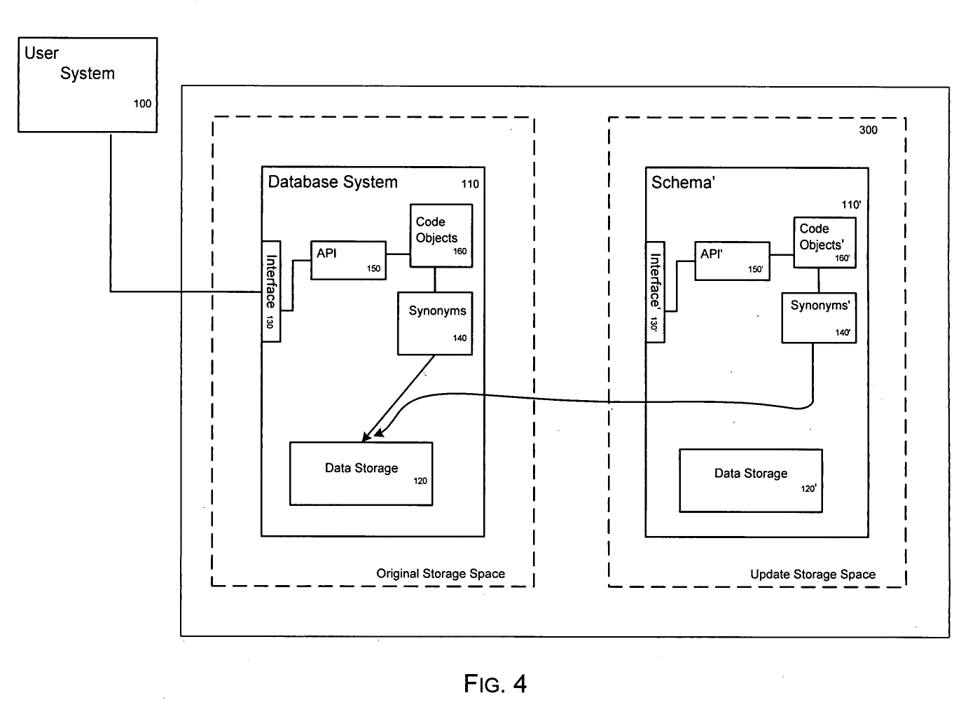

At 200, when the data storage 120 and/or application code objects 160 need to be updated, a schema of the database system 110 is generated and stored in an update storage space 300, illustrated in FIG. 3, while the database continues running in the original storage space according to one embodiment of the invention. In one embodiment the schema is generated upon initialization of the database system 110. In alternative embodiment the schema is generated when the database system 110 needs to be updated. Package specifications and bodies, synonyms, views, functions and procedures, triggers, object types, object privileges and system privileges of the database system 110 are maintained in the schema 110′. The layout of the data storage 120 is copied into the update storage space 300, the data itself stored in the data storage 120 is not maintained to reduce unnecessary data replication time. In one embodiment, the data storage layout may be stored in the different schema to separate locations of the application code and data storage.

At 210 the necessary changes are introduced into the schema 110′, for example, to the data storage 120′ data layout and/or into the application code objects 160′. For example, a set of new tables may be added to the data storage, a set of new columns may be added to a table, a new partition may be added to a table, code objects that access and manipulate data in the new partition may be introduced, etc. It will be appreciated that the invention is not limited to any particular changes and any changes can be made to the data storage 120′ layout and or application code objects 160′ in the update storage space.

At 220 the schema 110′ is tested in the update storage space 300 to ensure that all the introduced changes are compatible with the rest of the APIs 150′, code objects 160′ and database layout components. If errors are encountered, the necessary changes are introduced into the rest of the APIs 150′, code objects 160′ and database layout components in the update storage space to ensure compatibility with the introduced changes.

In one embodiment of the invention, upon successful testing of the updated schema, the database system 110 is taken off-line at 230. In one embodiment prior to taking the database system 110 off-line, the schema 110′ is synchronized with the database system 110 to ensure that changes that were introduced into the database system 110 while the schema was updated are incorporated into the schema. Upon synchronization the testing of the schema may be necessary.

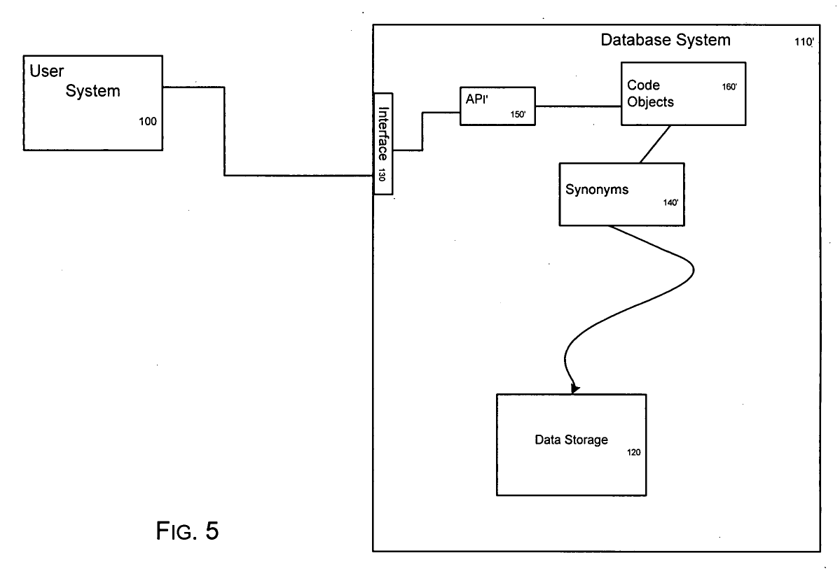

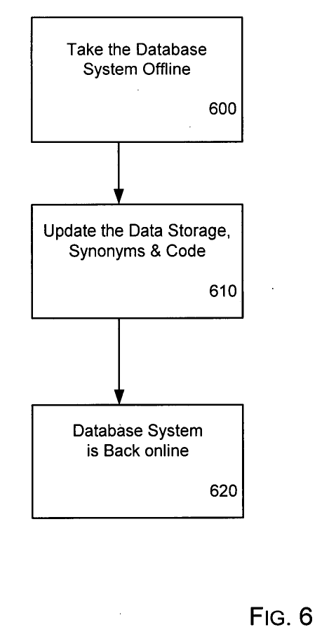

At 240 the necessary changes are introduced into the data storage 120 to match the updated data storage 120′. Synonyms 140′ are then repointed to the data storage 120 in the original database storage space at 250, as illustrated in FIG. 4. At 260, the user system 100 is directed to communicate with the repointed database system as illustrated in FIG. 5. The database downtime for system updates is thereby significantly reduced.

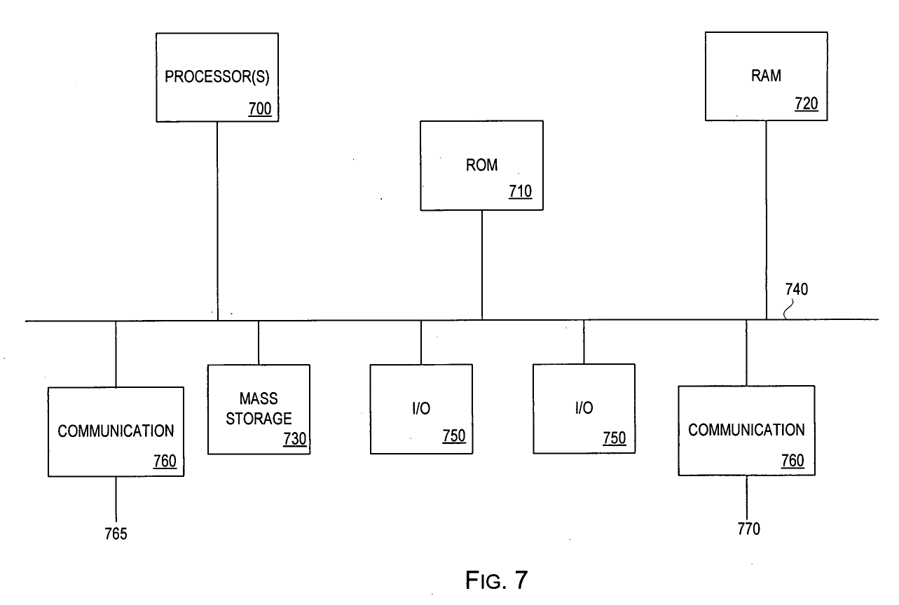

In another embodiment of the invention, upon successful testing of the schema, at 600 of FIG. 6 the database system 110 is taken off-line and at 610 the necessary changes are introduced into the database 110, synonyms 140, and the application code objects 160. The changes may be introduced by replacing the code objects, synonyms and data storage of the original database system with a copy of the updated schema. Alternatively, only portions of the original database system corresponding to the updated portions of the schema are modified. Once the database system is updated, the system is placed back online at 620. The database downtime is reduced as the updates have been already tested prior to their introduction into the original database system.

### General

It will be appreciated that physical processing systems, which embody components of database system described above, may include processing systems such as conventional personal computers (PCs), embedded computing systems and/or server-class computer systems according to one embodiment of the invention. FIG. 6 illustrates an example of such a processing system at a high level. The processing system of FIG. 7 may include one or more processors 700, read-only memory (ROM) 710, random access memory (RAM) 720, and a mass storage device 730 coupled to each other on a bus system 740. The bus system 740 may include one or more buses connected to each other through various bridges, controllers and/or adapters, which are well known in the art. For example, the bus system 740 may include a “system bus”, which may be connected through an adapter to one or more expansion buses, such as a peripheral component interconnect (PCI) bus or an extended industry standard architecture (EISA) bus. Also coupled to the bus system 740 may be the mass storage device 730, one or more input/output (I/O) devices 750 and one or more data communication devices 760 to communicate with remote processing systems via one or more communication links 765 and 770, respectively. The I/O devices 750 may include, for example, any one or more of: a display device, a keyboard, a pointing device (e.g., mouse, touch pad, trackball), and an audio speaker.

The processor(s) 700 may include one or more conventional general-purpose or special-purpose programmable microprocessors, digital signal processors (DSPs), application specific integrated circuits (ASICs), or programmable logic devices (PLD), or a combination of such devices. The mass storage device 730 may include any one or more devices suitable for storing large volumes of data in a non-volatile manner, such as magnetic disk or tape, magneto-optical storage device, or any of various types of Digital Video Disk (DVD) or Compact Disk (CD) based storage or a combination of such devices.

The data communication device(s) 760 each may be any device suitable to enable the processing system to communicate data with a remote processing system over a data communication link, such as a wireless transceiver or a conventional telephone modem, a wireless modem, an Integrated Services Digital Network (ISDN) adapter, a Digital Subscriber Line (DSL) modem, a cable modem, a satellite transceiver, an Ethernet adapter, Internal data bus, or the like.

The term “computer-readable medium”, as used herein, refers to any medium that provides information or is usable by the processor(s). Such a medium may take may forms, including, but not limited to, non-volatile and transmission media. Non-volatile media, i.e., media that can retain information in the absence of power, includes ROM, CD ROM, magnetic tape and magnetic discs. Volatile media, i.e., media that cannot retain information in the absence of power, includes main memory. Transmission media includes coaxial cables, copper wire and fiber optics, including the wires that comprise the bus. Transmission media can also take the form of carrier waves; e.g., electromagnetic waves that can be modulated, as in frequency, amplitude or phase, to transmit information signals. Additionally, transmission media can take the form of acoustic or light waves, such as those generated during radio wave and infrared data communications.

Thus, methods and apparatuses for updating databases have been described. Although the invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative sense rather than a restrictive sense.

1. A method comprising:
generating a schema of an original database system;
updating the schema while the original database system is online; and
repainting at least one synonym to an original data storage upon updating the original database system after successful testing of the schema.

2. The method of claim 1 wherein the schema includes at least one duplicate synonym and a duplicate data storage layout and wherein the original database system includes at least one original synonym and at least one original database.

3. The method of claim 1 wherein the generating the schema of the original database system includes generating a copy of original application code objects.

4. The method of claim 1 wherein the generating the schema of the original database system includes generating a copy of original package specifications and bodies, functions, procedures, triggers object types, object and system privileges.

5. The method of claim 1 wherein the generating the schema database system includes generating the schema upon initialization of the original database system.

6. The method of claim 1 wherein the generating the schema comprises generating the schema when the original database needs to be updated.

7. A method comprising:
generating a schema of an original database system and updating the schema while the original database system is online; and
integrating changes into the original database system upon successful testing of the schema.

8. The method of claim 7 wherein the integrating changes into the original database system includes replacing original synonyms with a copy of updated synonyms.

9. The method of claim 7 wherein the integrating changes into the original database system includes replacing original application code objects with a copy of updated code objects.

10. The method of claim 7 wherein the integrating changes into the original database system includes modifying portions of the original database system corresponding to updated portions of the schema.

11. An apparatus comprising:
means for generating a schema of an original database system in an update storage location, wherein the schema includes at least one synonym and a data storage layout and wherein the original database system includes at least one synonym and at least one data storage;
means for updating the schema while the original database system is online; and
means for repainting the at least one synonym to the original data storage upon updating the original database system after successful testing of the schema.

12. The apparatus of claim 11 wherein the generating the schema of the original database system includes generating a copy of application code objects.

13. An apparatus comprising:
means for generating a schema of an original database system and updating the schema while the original database system is online;
means for updating the schema; and
means for integrating changes into the original database system upon successful testing of the schema.

14. The apparatus of claim 13 wherein the means for integrating changes into the original database system include means for replacing original synonyms with a copy of updated synonyms.

15. The apparatus of claim 13 wherein the means for integrating changes into the original database system include means for replacing original application code objects with a copy of updated code objects.

16. The apparatus of claim 13 wherein the means for integrating changes into the original database system include means for modifying portions of the original database system corresponding to the updated portions of the schema.

17. An article of manufacture comprising:
a computer-readable medium having stored therein instructions which, when executed by a processor, cause a processing system to perform a method comprising:
generating a schema of an original database system in an update storage location;
updating schema while the original database system is online; and
repointing the at least one synonym to an original data storage upon updating the original database system after successful testing of the schema.

18. The article of manufacture of claim 17 wherein the instructions, which when executed by the processor, cause the processing system to perform the method wherein the duplicate database system includes at least one synonym and a data storage and wherein the original database system includes at least one original synonym and at least one original data storage.

19. An article of manufacture comprising:
a computer-readable medium having stored therein instructions which, when
executed by a processor, cause a processing system to perform a method comprising:
generating a schema of an original database system and updating the schema while the original database system is online; and
integrating changes into the original database system upon successful testing of the updated schema.

20. The article of manufacture of claim 19 wherein the instructions, which when executed by the processor, cause the processing system to perform the method wherein the integrating changes into the original database system includes replacing original synonyms with a copy of updated synonyms.

21. The article of manufacture of claim 19 wherein the instructions, which when executed by the processor, cause the processing system to perform the method wherein the integrating changes into the original database system includes modifying portions of the original database system corresponding to the updated portions of the schema.
